(19) United States
(12) Patent Application Publication
(10) Pub. No.: US 2023/0291740 A1
(43) Pub. Date: Sep. 14, 2023

(54) Systems and Methods for Providing Support Services in a Virtual Environment

(71) Applicant: Helpshift, Inc., San Francisco, CA (US)

(72) Inventor: Erik Ashby, Lehi, UT (US)

(21) Appl. No.: 18/120,631

(22) Filed: Mar. 13, 2023

Related U.S. Application Data
(60) Provisional application No. 63/319,611, filed on Mar. 14, 2022.

(51) Int. Cl. H04L 9/40; G06Q 30/015

(52) U.S. Cl. CPC H04L 63/102; G06Q 30/015; H04L 63/083

(57) ABSTRACT

Systems and methods for enabling a person who is experiencing and interacting in a virtual environment to obtain customer support or another form of assistance within the environment for an object, service, or experience they interact with in the virtual environment.

### CROSS REFERENCE TO RELATED APPLICATION

This application claims the benefit of U.S. Provisional Application No. 63/319,611, filed Mar. 14, 2022, and titled “Systems and Methods for Providing Support Services in a Virtual Environment”, the contents of which is incorporated in its entirety (including the Appendix) by this reference.

### BACKGROUND

Virtual and augmented reality experiences are becoming more and more popular.

Typically, a user enters and interacts with a virtual environment using a dedicated device, such as a headset or glasses. A natural evolution of this type of experience is that of a person being represented by an avatar that exists and interacts within a virtual world with objects, other avatars, and the virtual environment. In some cases, this virtual world or reality may be augmented by images or representations of objects in the real, physical world. Such a virtual world or environment has been termed a “metaverse¹”.

As with the physical “real” world, a person experiencing the metaverse may encounter a problem in using a product or service, such as a virtual application, a delivery service, a virtual device, a business-related service, or another aspect of a virtual world. In some cases, the virtual form of an application or device may correspond to an actual real-world version of the same application or device. Whereas in the physical world, a person would contact the store from which they purchased a product, or the “brand” represented by the product or service to obtain customer support or another form of assistance, this approach is not possible in a virtual environment.

The reasons for this are several but in general, may typically be described as relating to one or more of the following:
a lack of a contact within the virtual environment for a specific product or service from which to seek assistance, and an effective way to describe the support desired within the virtual environment;
   this is an example of the limits of a virtual environment and the necessity for a user to exit that environment to perform certain tasks;
      in one sense, this is a result of a lack of a way to seek support for a product or service in the virtual environment without leaving the virtual environment and instead needing to contact a customer service or support provider using a communication channel outside of the virtual environment;
      similarly, this is a result of not having design elements that logically fit into the vastly different types of possible virtual environments and that provide a clear way for an avatar/user to seek assistance; that is, a lack of a standardized and recognizable form or process within the virtual environment for seeking support assistance with applications, products, services, or features of the virtual environment;
in many cases, the insufficiency of support services also results from a need to provide a customer service or support representative with contextual information about the service request, such as a product or service type, a location, an identity of a service requester, a serial number or other identification of a product, a current state, error messages or error codes for a product or service, as examples, and an inability to provide that information to a source of assistance while in a virtual environment;
   in some cases, this information may not be available or even if available, there may not be a process for collecting and/or transferring the information to the appropriate object or avatar in the virtual environment to obtain the desired assistance;
a lack of a verifiable association between an avatar in the virtual environment and a real (physical) person to enable user authentication, verification, and personalized and secure assistance or support services;
   this relates to the problem of establishing a verifiable identity for an avatar so that the avatar or the real person represented by the avatar can be associated with a virtual world product or service and the avatar can be authorized to request and receive the support services;
      this also relates to the need for a secure identity verification system that protects personal data and information from compromise, whether the personal data or information is provided by a real person or by their avatar;
a lack of an infrastructure to provide customer support in a multi-brand environment to enable a user to obtain assistance from multiple entities in a decentralized economic system while remaining in the metaverse experience;
   this relates to the problem of a virtual environment containing products or services from multiple sources and a person (in the form of their avatar) desiring a support service available for each without leaving the virtual environment, and considering the product, service, or context (where relevant to the request) for the customer service or support request;
      this also indicates the significance of collecting relevant contextual or identifying data about a product or service and enabling it to be provided to the appropriate object or avatar in the virtual environment;
         for example, in the “real” physical world, the context in which a request for customer service arises may include day, time, current state of a device, displayed or inferred error messages, and this information is used by a customer service provider to determine how best to assist a customer;
      this concern may also relate to the lack of an ability to obtain assistance from other people/avatars, which in some cases may be beneficial in providing a solution to a user's problem by accessing the “wisdom” and experience of a group.

Embodiments of the systems and methods described herein are directed to solving these and related problems individually and collectively.

### SUMMARY

The terms “invention,” “the invention,” “this invention,” “the present invention,” “the present disclosure,” or “the disclosure” as used herein are intended to refer broadly to all the subject matter disclosed in this document, the drawings or figures, and to the claims. Statements containing these terms do not limit the subject matter disclosed or the meaning or scope of the claims. Embodiments covered by this disclosure are defined by the claims and not by this summary. This summary is a high-level overview of various aspects of the disclosure and introduces some of the concepts that are further described in the Detailed Description section below. This summary is not intended to identify key, essential or required features of the claimed subject matter, nor is it intended to be used in isolation to determine the scope of the claimed subject matter. The subject matter should be understood by reference to appropriate portions of the entire specification, to any or all figures or drawings, and to each claim.

Embodiments of the disclosure are directed to a system and methods for enabling a person who is experiencing and interacting in a virtual environment to obtain customer support or another form of assistance within the environment for an object, service, or experience they interact with in the virtual environment. In some embodiments, the disclosed system and methods may comprise elements, components, or processes that are configured and operate to provide one or more of:
Support services for a virtual environment and/or location in the virtual environment containing “objects” representing devices, experiences, products, or services associated with a plurality of sources or brands, and that may be utilized within the virtual environment;
Support services that consider the context of one or more of the requester/avatar, the object for which assistance is requested, the virtual environment, the location in the virtual environment, and the relationships between them;
A secure and verifiable way of determining the rights or abilities of an avatar to request and receive support services. The methodology or approach used to perform this function may vary, depending upon the requested form of assistance, and whether the rights pertain to the avatar and/or to the person controlling the avatar. As non-limiting examples, it may be necessary to:
   verify the association of an avatar with a real person and establish the rights or permissions of that person;
   verify the identity and rights of an avatar with a verifiable token (such as an NFT), where this may relate to the rights of the avatar in the virtual environment and may not require confirmation of the identity of the person controlling the avatar;
   verify the identity of an avatar using a secure and accepted verification method in the virtual environment;
      in each example, a goal is to enable the avatar to identify itself and establish its rights, privileges, or entitlements, and/or to enable a person to provide “proof” of their association with (or control of) the avatar (if necessary in the situation) and to establish their rights;
      in some cases, identity verification may be part of a process to enable an avatar or real person to establish their ownership of an object, or their entitlement to use a service or type of support;
   this illustrates how the method used to verify identity may vary depending on the context in which the request for assistance is generated;
      in some cases, an avatar may be part of a transaction involving a transfer of “credits” or virtual funds—in this case, it may not be necessary to verify the identity of the person controlling the avatar to provide the requested assistance;
      in some cases, an avatar may be interacting with a service provider in the real world—in this case, it may be necessary to verify that the avatar is being controlled by the person who is authorized to receive the assistance;
Support services in the virtual environment that can (if needed) connect and communicate with “real” world digital platforms and support tools, and real-world support agents to obtain the requested assistance;
   this interconnection between the virtual environment and real-world support tools may be used so that existing real-world support agents can support the virtual world without changing their support workload or practices;
      as an example, a support agent may use a CRM tool to respond to or engage in a “chat” with support requests. These agents can continue to respond as needed to a request made in the virtual space, while continuing to provide services to requests for assistance made in the real-world;
   this interconnection between the virtual environment and the physical real world may include services provided in the virtual environment that are tied to the support of real-world objects represented in the virtual space;
      as an example, this would permit a user (in the form of their avatar) to obtain customer assistance in the virtual environment for an object in that environment where the object has a real-world version owned by the user and the customer assistance can be applied to the real-world object; and
Support services in the virtual environment may be accessed using virtual/augmented reality devices and techniques, and support may be provided for a location in the virtual environment, an object, or an asset, and support may be obtained from a menu/kiosk, or otherwise integrated with a virtual world experience.

As part of, or in addition to, enabling the provision of customer support services or other types of assistance within a virtual environment, the disclosed systems and methods may also provide the following advantages, services, or capabilities:
Consideration of the context in the virtual environment that may be needed to provide automated or self-help support;
   this relates to the fact that in the virtual environment the type of support that is needed may depend on the context at the time assistance is requested, especially for self-help or automated support;
      for example, for self-help or automated help to be provided within a virtual environment, the system may need to know where an avatar is, what objects or avatars they might be interacting with, and what the avatar is doing so that the appropriate help or automated assistance can be provided;
An effective infrastructure to provide customer support in a multi-brand virtual environment and to enable the user to obtain assistance from the correct entity when multiple entities exist;
   this relates to the situation that in a virtual environment, the user experience is not provided by a single brand, but instead by a mixture of experiences, objects, and services that are created by multiple brands;
   for example, in the virtual world, an avatar may be standing in a virtual mall surrounded by different stores, where each store experience is created by a different brand;
   similarly, in the virtual world, an avatar may be in their own virtual space, but own specific virtual objects (such as a painting, a virtual car, a radio, or other object) that are created by different brands and for which they desire support if the object is not performing as expected in this world.

In some embodiments, a user may obtain the customer service or support using a device such as a smartphone or tablet computer. In such situations, the following functions or capabilities may be provided:
The user's phone may function as a “window” for viewing and interacting with a specific virtual or augmented reality environment;
The “window” may include an element for requesting support in the virtual environment (such as a kiosk in the virtual environment) that can be used to submit a request for support and to initiate a support experience;
The provided support may be based on or include consideration of elements of the real-world context of the requester and/or those of the virtual environment;
   as an example, such as by combining a requestor's real-world identity with their real or virtual location and information about one or more objects in the virtual environment; and
Support services may be provided in an augmented reality experience/environment in which connection and communication with real-world support tools and/or support agents is enabled, and information or other forms of assistance can be transferred between the virtual/augmented environment and the real environment.

In some embodiments, in addition to providing customer support and other services for objects in a virtual environment, the disclosed system and methods may provide one or more of the following functions or capabilities:
An identity verification and (for an avatar and/or user) authorization process that can perform one or more of the following tasks:
   identify and determine the rights of an avatar or person controlling an avatar;
   relate an identity for an avatar in a virtual environment to a real-world person;
   determine if the real-world person (and by extension their avatar) are authorized to receive support services (or services of a particular type) for an object in the virtual environment;
   this may include the ability to generate an identity for a user that can be used in the virtual environment if they do not presently have one;
   this may include the ability to verify the identity and authorized services that can be provided to an avatar and/or real-world person using data stored on a blockchain, by processing an NFT, or by using other secure and accepted verification method (such as multi-factor and/or multi-channel authentication);
An ability to notify support services in the virtual environment and/or the real-world when a user or service requester cannot be verified;
   this is to prevent a person/avatar from obtaining access to resources or assistance that they are not entitled to;
A set of processes to enable a service or support request to be associated with a user and treated as an object or asset belonging to the user/avatar;
   this allows the user (in the form of their avatar) to transfer the support request to others for advice or assistance;
      this capability can enable the development of an economy or market in the virtual environment based on the value of service requests (e.g., by establishing ownership of property and the opportunity for bidding, exchange, valuation, or other forms of property transfer), and encourage and enable collaboration within the virtual environment to more effectively address service requests.

In one embodiment, the disclosure is directed to a method for providing customer service or support within a virtual or augmented reality environment. In one embodiment, the disclosed method may include the following steps, stages, functions, processes, or operations:
Receive or identify a request from an avatar in a virtual environment for assistance with a product or service, with the product or service represented as an object in the virtual environment;
   as non-limiting examples, the request may be generated by the avatar visiting a kiosk, sending a communication, identifying the object and executing a process or operation (such as touching an element on the object or picking up the object), or moving to a specific location in the virtual environment (such as a marker or building);
   a real person may also access the virtual environment via a web-page, a mobile application, or other support interface and may not be required to have an avatar;
In response to the request, identify the product or service for which assistance is requested and determine if the avatar (and by inference, the real-world person/user corresponding to the avatar) is authorized to obtain the requested assistance;
   With regards to the avatar, this may include determining the identity, location, and/or context of the avatar in the virtual environment and the services it is authorized to receive (this may be accomplished using blockchain data, an NFT or other token, or other form of verification or authentication), and/or determining the real-world person that is supposed to correspond to the avatar and verifying that the authorized person is controlling the avatar when the request is made;
      When needing to verify the identity of the real-world person in control of an avatar, in some embodiments, this may involve a form of two-factor and/or two-channel authorization that uses both virtual and real-world objects, devices or processes as a channel for transmission, or a source of, verification data;
   With regards to the object representing a product or service, this may include verifying that the real-world person is entitled to receive the requested assistance for the virtual environment product or service;
      To accomplish this, specific information about the object may need to be collected, including but not limited to (or required to include):
         Identifying the object by one or more of name, brand, serial number, model, version, or type, as examples;
         Identifying the source of the object (if not apparent from the brand), such as a real-world or virtual-world store, or other form of provider; and
         Determining the relationship between the object and the requester (such as if the requester is an owner, a licensed user, or is associated with an NFT, as non-limiting examples);
   Notifying the virtual world recipient of the request and/or the real-world support services for the object as to whether the avatar/user is entitled to use the support services;
If the requester is authorized to obtain the requested assistance, then collecting, accessing, or otherwise obtaining contextual information about the object (the product or service, and if not already obtained), the type of assistance requested, the avatar/user, the avatar's relationship to the object, or other information as needed by the customer service provider. This information may include but is not limited to (or required to include):
   Identifying the object by one or more of name, brand, serial number, model, version, or type, as examples;
   Identifying the source of the object (if not apparent from the brand), such as a real-world or virtual-world store, or other form of provider;
   Determining the relationship between the object and the requester (such as if the requester is an owner, a licensed user, or is entitled to other form of control, as examples);
   The location of the avatar in the virtual environment and the relationship to the product or service for which support is requested (as previously mentioned);
   The location of the real-world user (if relevant to the service request); and
   The state or status of the object (such as if an error code was generated, the configuration of the object, the process or function the product was requested to execute or was executing, or other relevant information as non-limiting examples);
Based on the obtained contextual information, determining the proper source and form of assistance to provide to the avatar/requester, and initiating a process to obtain that assistance;
   This may include connecting to and communicating with a real-world source of customer service or support information, such as a digital support platform that may include or provide access to a website, a chatbot, a set of documents, and agent tools to service requests, as examples;
Obtaining the requested assistance in the form of a communication, information, instructions, a video to watch, or a process to execute (which may be provided in the form of an object or token for an avatar to interact with), as non-limiting examples; and
Providing the assistance to the requester (in the form of their avatar);
   The requested assistance may be provided by a kiosk, a customer service avatar, a store front, or a virtual communication device (such as a video screen), as examples;
   When provided to the avatar/requester, an indicator on a product or one associated with the service request when it is viewed as an object may be altered (such as a change to its color, shape, or appearance, as examples) to indicate that the service request has been completed and the problem resolved.

In one embodiment, the disclosure is directed to a system for providing customer service or support within a virtual environment. The system may include one or more non-transitory computer-readable media including a set of computer-executable instructions and an electronic processor or co-processors. When executed by the processor or co-processors, the instructions cause the processor or co-processors (or a device or apparatus of which they are part) to perform a set of operations that implement an embodiment of the disclosed method or methods.

In one embodiment, the disclosure is directed to one or more non-transitory computer-readable media including a set of computer-executable instructions, wherein when the set of instructions are executed by an electronic processor or co-processors, the processor or co-processors (or a device or apparatus of which they are part) perform a set of operations that implement an embodiment of the disclosed method or methods.

In some embodiments, the systems and methods described herein may provide services through a SaaS or multi-tenant platform. The platform provides access to multiple entities, each with a separate account and associated data storage. Each account may correspond to a user, set of users, an entity offering users customer services and support, or an organization, for example. Each account may access one or more services, a set of which are instantiated in their account, and which implement one or more of the methods or functions described herein.

Other objects and advantages of the systems and methods described will be apparent to one of ordinary skill in the art upon review of the detailed description and the included figures. Throughout the drawings, identical reference characters and descriptions indicate similar, but not necessarily identical, elements. While the exemplary embodiments disclosed or described herein are susceptible to various modifications and alternative forms, specific embodiments have been shown by way of example in the drawings and will be described in detail herein. However, the exemplary or specific embodiments are not intended to be limited to the forms disclosed. Rather, the present disclosure covers all modifications, equivalents, and alternatives falling within the scope of the appended claims.

### BRIEF DESCRIPTION OF THE DRAWINGS

Embodiments of the invention in accordance with the present disclosure will be described with reference to the drawings, in which:

FIG. 1(a) is a diagram illustrating a system including a set of elements, components, functions, or processes that may be implemented as part of some embodiments;

FIG. 1(b) is a flowchart or flow diagram illustrating a method, process, set of operations, or set of functions for enabling a person to obtain customer service or assistance for an object in a virtual environment without leaving the virtual environment, in accordance with some embodiments;

FIG. 2 is a diagram illustrating elements or components that may be present in a computer device, server, or system configured to implement a method, process, function, or operation in accordance with some embodiments; and

FIGS. 3-5 are diagrams illustrating an architecture for a multi-tenant or SaaS platform that may be used in implementing an embodiment of the systems and methods disclosed herein.

Note that the same numbers are used throughout the disclosure and figures to reference like components and features.

### DETAILED DESCRIPTION

The subject matter of embodiments of the present disclosure is described herein with specificity to meet statutory requirements, but this description is not intended to limit the scope of the claims. The claimed subject matter may be embodied in other ways, may include different elements or steps, and may be used in conjunction with other existing or later developed technologies. This description should not be interpreted as implying any required order or arrangement among or between various steps or elements except when the order of individual steps or arrangement of elements is explicitly noted as being required.

Embodiments of the disclosure will be described more fully herein with reference to the accompanying drawings, which form a part hereof, and which show, by way of illustration, exemplary embodiments by which the disclosure may be practiced. The disclosure may, however, be embodied in different forms and should not be construed as limited to the embodiments set forth herein; rather, these embodiments are provided so that this disclosure will satisfy the statutory requirements and convey the scope of the disclosure to those skilled in the art.

Among other things, the present disclosure may be embodied in whole or in part as a system, as one or more methods, or as one or more devices. Embodiments of the disclosure may take the form of a hardware implemented embodiment, a software implemented embodiment, or an embodiment combining software and hardware aspects. For example, in some embodiments, one or more of the operations, functions, processes, or methods described herein may be implemented by one or more suitable processing elements (such as a processor, microprocessor, CPU, GPU, TPU, or controller, as non-limiting examples) that is part of a client device, server, network element, remote platform (such as a SaaS platform), an “in the cloud” service, or other form of computing or data processing system, device, or platform.

The processing element or elements may be programmed with a set of executable instructions (e.g., software instructions), where the instructions may be stored on (or in) one or more suitable non-transitory data storage elements. In some embodiments, the set of instructions may be conveyed to a user through a transfer of instructions or an application that executes a set of instructions (such as over a network, e.g., the Internet). In some embodiments, a set of instructions or an application may be utilized by an end-user through access to a SaaS platform or a service provided through such a platform.

In some embodiments, one or more of the operations, functions, processes, or methods described herein may be implemented by a specialized form of hardware, such as a programmable gate array, application specific integrated circuit (ASIC), or the like. Note that an embodiment of the disclosure may be implemented in the form of an application, a sub-routine that is part of a larger application, a “plug-in”, an extension to the functionality of a data processing system or platform, or other suitable form. The following detailed description is, therefore, not to be taken in a limiting sense.

As mentioned, in some embodiments, the systems and methods described herein may provide services through a SaaS or multi-tenant platform. The platform provides access to multiple entities, each with a separate account and associated data storage. Each account may correspond to a user, set of users, an entity offering users customer services and support, or an organization, for example. Each account may access one or more services, a set of which are instantiated in their account, and which implement one or more of the methods or functions described herein.

As used herein, the terms “metaverse”, “virtual environment”, “virtual reality”, or “virtual world” refer to a computer-simulated environment which may be populated by multiple users who can each create and be represented by a personal avatar, and simultaneously and independently explore the virtual world, participate in its activities, interact with objects, and communicate with others.² A virtual world or environment may include aspects of the physical or real-world, in which case the experience may be referred to as an “augmented reality”.

As non-limiting examples, when users interact in and with the metaverse, they may experience one or more of the following:
persistent, virtual interactive 3-dimensional worlds and immersive experiences (which are accessed via one or more of VR, AR, and mobile devices, as examples);
mixed brand experiences involving products or services provided by multiple and different sources;
decentralized self-sovereign identities, with each identity/avatar owned and controlled by an individual in the real-world;
decentralized metaverse assets/objects that may be owned by one or more individuals/avatars;
virtual objects that may include land, structures, locations, works of art, tokens, rewards, equipment, services, devices, specific functions, or executable processes, as non-limiting examples;
   in some embodiments, a virtual object may correspond to an actual object in the real-world, such as a location, a building, a company, a device, or an animal, as non-limiting examples; and
a decentralized economy, in which objects may be associated with non-fungible tokens (NFTs), and the availability of direct person (i.e., avatar)-to-person (avatar) transactions.

In some embodiments, to provide “contextual” based customer support in a virtual world for a virtual product or virtual service may involve implementation of one or more of the following functions or capabilities, as disclosed herein:
Existence of a virtual object (such as a ball, a service emblem, a designated location, or a kiosk, as non-limiting examples) or an event trigger (such as an avatar pressing a button, standing on a square, or moving to a designated location, as non-limiting examples) that can be used by an avatar to generate a request for support and/or initiate a support experience;
Awareness of the context of the user/avatar in the virtual environment including as non-limiting examples, the virtual location, nearby objects, the avatar's recent/current experience or actions, the avatar's virtual or corresponding real-world identity, or the brand ownership or association (if applicable) for an object;
   For example, awareness that a person's avatar is in a virtual Starbucks lounge, sitting at a table, in front of a game of chess;
A virtual identity (typically an avatar) that is managed by a real-world person/user and associated with specific data that can be shared by the user corresponding to the avatar with support service providers to authenticate the user and establish that they are entitled to the desired support services (such as verification that they are 18, or that they have paid for the product or service, as examples);
   The data or information used to establish the rights or privileges of an avatar and/or a person, or to verify the identity of a person controlling an avatar may be stored or encoded in a blockchain, associated with an NFT, or other suitable data storage component;
A virtual environment experience with which a user's avatar can interact to obtain support, including (as examples) self-help sources, artificial intelligence driven menus, a voice chat, a text chat with voice-to-text capabilities, a device that presents a video, a display for presenting a document, or interactive workflows, as non-limiting examples;
   In some embodiments, a service agent chat record or voice chat may appear as a hologram or an avatar that another avatar can interact with; and
A support platform and routing service to execute or otherwise provide an experience based on the specific context of the avatar and/or the product or service for which support is requested;
   For example, if the user is in a virtual Starbucks, then Starbucks help will be displayed;
   The provided experience may include but is not limited to or required to include use of a bot, an automated event or sequence of events, a connection/routing to a real-world agent, a help or customer support ticketing process, or support agent communication tools, as non-limiting examples.

One aspect that makes the challenge of providing customer service or support in a virtual environment more difficult than in the real-world is that in a virtual world there can be many different objects, types of objects, products, services, and places, and each may be associated with a different source or brand. For example, a person's avatar may be in their virtual living room with several different objects on a counter that were purchased from different brands (a virtual book, a virtual board game, a virtual device, and a portal to a virtual experience, for example). Each object would be expected to have different support needs and different contextual information, and a support platform needs to be able to distinguish between each object and then present support services applicable to that object from its associated source or brand.

In contrast, in a conventional real-word environment, each brand and their support are self-contained, and the support is presented inside of a desktop application, a dedicated chat, a web-page, or a mobile application, as examples. However, in a virtual environment, brands will be interspersed and provide different products, services, or experiences at the same time and often in the same place in the virtual environment. Because of this situation, it is important to have sufficient contextual information available about the virtual world and the virtual object of interest to determine what support services to present. The contextual information may be related to specific objects, locations, states, events, or triggers unique to the brand or source of an object.

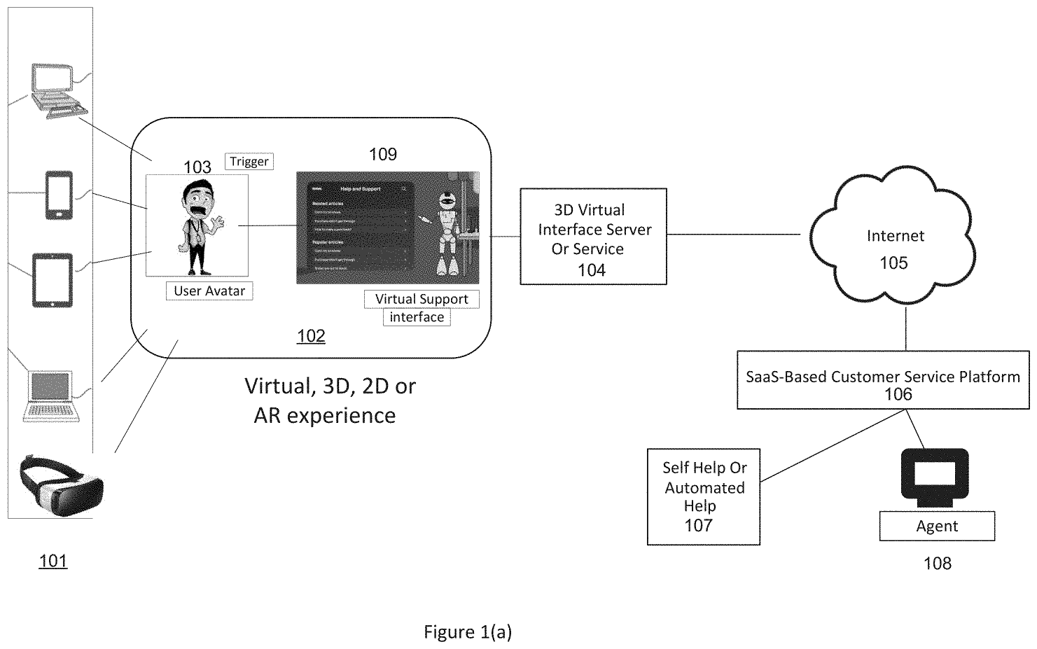

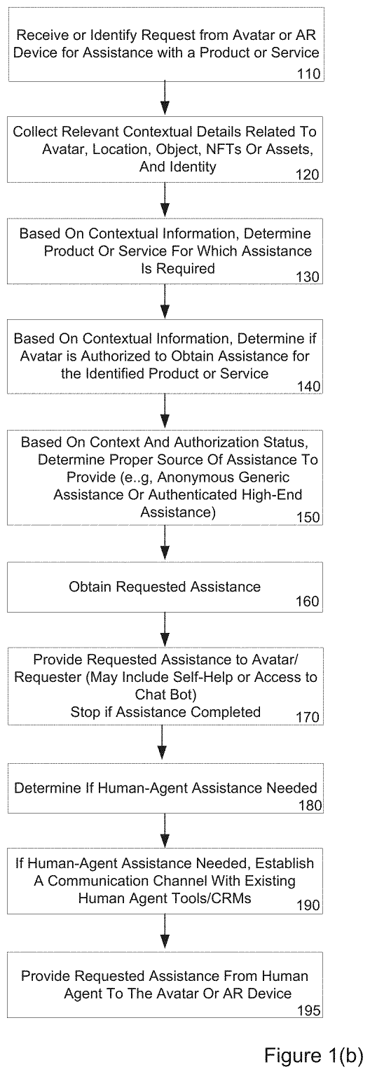

FIG. 1(a) is a diagram illustrating a system including a set of elements, components, functions, or processes that may be implemented as part of some embodiments. As shown in the figure, a real-world person uses a suitable device 101 to experience and interact with a virtual experience or environment 102. The device may be a computing device, mobile phone, tablet, or dedicated virtual reality headset, as non-limiting examples. The virtual experience or environment 102 may be one of a virtual (artificial) reality, augmented reality, or similar experience, and may be provided by a gaming or interactive application.

Within virtual experience or environment 102, the real-world person using device 101 may be represented by an avatar 103. Virtual experience or environment 102 may be generated and managed by a remote server 104 (as suggested by the element labeled “3D Virtual Interface Server or Service” in the figure). Server 104 may be operated by the provider of the gaming or interactive application the real-world person is using. Server 104 is typically connected to and able to exchange data and information using the Internet 105 and/or one or more intermediate networks.

A SaaS-based customer service platform 106 may also be connected to the Internet 105 and therefore able to exchange data and information, and interact with virtual experience or environment 102, typically via server 104. SaaS-based customer service platform 106 may be connected to and able to provide customer assistance by routing a service or assistance request to a set of self-help or automated help resources 107 (such as a set of documents, links to resources, or a chatbot, as non-limiting examples), and/or to service agents 108 in the form of a real person using a suitable computing device.

In one embodiment, the operator of SaaS-based customer service platform 106 may provide the source of the game, application, interactive experience, or other virtual reality or augmented reality environment or experience (i.e., the operator of server 104, as an example) with one or more of the following elements, components, or processes:
A module, plug-in, or application that may be used to determine that support is needed for an object in the virtual experience or environment and to collect or identify the contextual data and information needed to provide effective support services;
A virtual reality, augmented reality, or mobile device customer support module (i.e., an application, routine, or executable set of instructions to accomplish a function, as examples) to provide customer service and other forms of assistance that a “brand” may integrate into a virtual reality or augmented reality experience or environment that it is creating and/or managing;
   in some embodiments, a user of a mobile application on a mobile device may be able to seek (or make a request) for support and then go through a process by which an independent ticket is created that is owned by the user and has the same aspects/properties as disclosed herein for a service request object;
A digital customer service and support platform (such as platform 106, or an account on a multi-tenant platform) connected to the virtual reality, augmented reality, or mobile device customer support module and able to exchange data and information with that module; and
Connectivity and access to self-help and agent tools and resources so that the customer support module can access and utilize the self-help and/or real person agents.

In some embodiments, one or more of the modules used to determine if support is needed or the customer support module may generate a user interface within the virtual or augmented reality environment 109 to enable avatar 103 to interact with customer support services. Interface 109 may include selectable or activatable elements that avatar 103 may use to indicate a product model or type of service for which assistance is desired, the type of assistance desired, or another aspect of a service request.

As suggested by the “trigger” element in the figure, in some embodiments, a service request may be generated automatically in response to a situation or event. For example, an error message, an avatar performing a specific action or going to a specific place, or an object representing a product or service changing its appearance may be a form of “trigger” and may indicate that assistance is needed and may in some embodiments generate a service request or ticket.

FIG. 1(b) is a flowchart or flow diagram illustrating a method, process, set of operations, or set of functions for enabling a person to obtain customer service or assistance for an object in a virtual environment without leaving the virtual environment, in accordance with some embodiments. In some embodiments, the illustrated method, process, set of operations, or set of functions may be performed by executing a set of computer-executable instructions, some of which may be executed in a client device and some in a remote server platform.

As disclosed, in some embodiments, a person may obtain customer service or assistance for an object or service in a virtual environment without leaving the virtual environment by implementing the following steps or stages:
A customer support or assistance platform (such as SaaS-Based Platform 106 of FIG. 1(a)) receives or identifies a request from an avatar (such as Avatar 103 in FIG. 1(a)) in a virtual environment for assistance with a product or service (as suggested by step or stage 110);
   in one embodiment, the customer support or assistance platform may receive or identify that a request has been made by the avatar sending a message, visiting a kiosk, moving to a specific position in the virtual environment, pointing to an object in the virtual environment, changing a state of an object, or performing an action related to an object, as non-limiting examples;
   in one embodiment, the platform may become aware of a request for assistance by a module or process in a virtual environment sending the platform a request, generating a request object, or altering a characteristic of an object (such as its color or state of operation);
in response to the request, a module or process operates to collect relevant contextual details related to one or more of the avatar, the avatar location, the object or service, NFTs or others assets associated with the avatar, or the identity of the avatar or the person controlling the avatar (as suggested by step or stage 120);
   in one embodiment, this may include accessing a blockchain, NFT (non-fungible token), or other data storage element or component;
   in one embodiment, the contextual information about the object, the type of assistance requested, the avatar/user's profile information, or the avatar's relationship to the object may include but is not limited to or required to include:
      identifying the object by name, brand, serial number, model, version, or type, as non-limiting examples;
      identifying the source of the object (if not apparent from the brand), such as a real-world or virtual world store;
      determining the relationship between the object and the requester (such as if the requester is an owner or licensed user, as non-limiting examples);
      the location of the avatar in the virtual environment and the relationship to the product or service for which support is requested;
      the location of the real-world user; and
      the state or status of the object or service for which assistance is requested (such as if an error code was generated, the configuration of the object, the process or function the product was requested to execute or was executing, as non-limiting examples);
Based on the collected contextual information, the customer support or assistance platform (or the embedded module) determines the product or service for which assistance has been requested or is required (as suggested by step or stage 130);
   in one embodiment, this may be because of the avatar's action and/or a change in the appearance of the object in the virtual environment (such as the object changing color, glowing, or blinking, as examples);
Based on the collected contextual information, the customer support or assistance platform (or the embedded module) determines if the avatar (and by inference the person associated with the avatar) is authorized to obtain assistance for the identified product or service (as suggested by step or stage 140);
   this may include determining, confirming, or verifying the identity of the real-world person corresponding to the avatar and controlling it in the virtual environment;
      to protect a person's data and privacy, this may include use of a specific security protocol, data exchange protocol, data format, or data storage methodology, as non-limiting examples;
         in one embodiment, identification data for a real-world person and an indication of their virtual world identify may be stored on a blockchain, encrypted, represented by a token, and/or subject to use restrictions, as non-limiting examples;
   this step or stage may also include verifying that the real-world person is entitled to receive the requested assistance for the specific virtual environment product or service;
      to accomplish this, information about the object may need to be collected (if not already collected as part of a previous step or stage), including but not limited to or required to include:
         identifying the object by name, brand, serial number, model, version, or type, as non-limiting examples;
         identifying the source of the object (if not apparent from the brand), such as a real-world or virtual world-store; and
         determining the relationship between the object and the requester (such as if the requester is an owner or licensed user, as non-limiting examples);
Based on the context and authorization status, determine the proper source and form of assistance to provide (this source may include anonymous generic assistance or higher-end assistance based on the result of the authentication process), as suggested by step or stage 150;
   this may include connecting to and communicating with a real-world source of customer service or support information, such as a website, chatbot, a set of documents, or an agent, as non-limiting examples;
Obtaining the requested assistance in the form of a communication, information, instructions, or a process to execute (which may be in the form of an object, as suggested by step or stage 160); and
Providing the assistance to the requester (in the form of their avatar, as suggested by step or stage 170), where, as examples;
   the requested assistance may be provided by a virtual environment kiosk, a customer service avatar, a store front, a virtual communication device, a popup virtual environment display, or an experience on a mobile device operated by the requester, as non-limiting examples;
      this may include a chat experience or session that can be displayed in the virtual environment, on a mobile phone, or other related experience, where the chat can be provided using a speech-to-text capability;
   when provided to the avatar/requester, an indicator on a product or associated with the service request when it is viewed as an object may be altered (such as a change to its color, shape, or appearance);
   the requested and provided assistance may include a source of self-help (such as a set of links, FAQs, or documents), or access to a chatbot;
   terminating the assistance request if providing assistance has been completed;
Determining if assistance in the form of a human agent is needed (as suggested by step or stage 180);
If human-agent assistance is needed, then establishing a communication channel with existing human agent tools/CRMs (as suggested by step or stage 190); and
Providing the requested assistance (or whatever else and in whatever form has not yet been provided) from a human agent to the avatar or AR device (as suggested by step or stage 195).

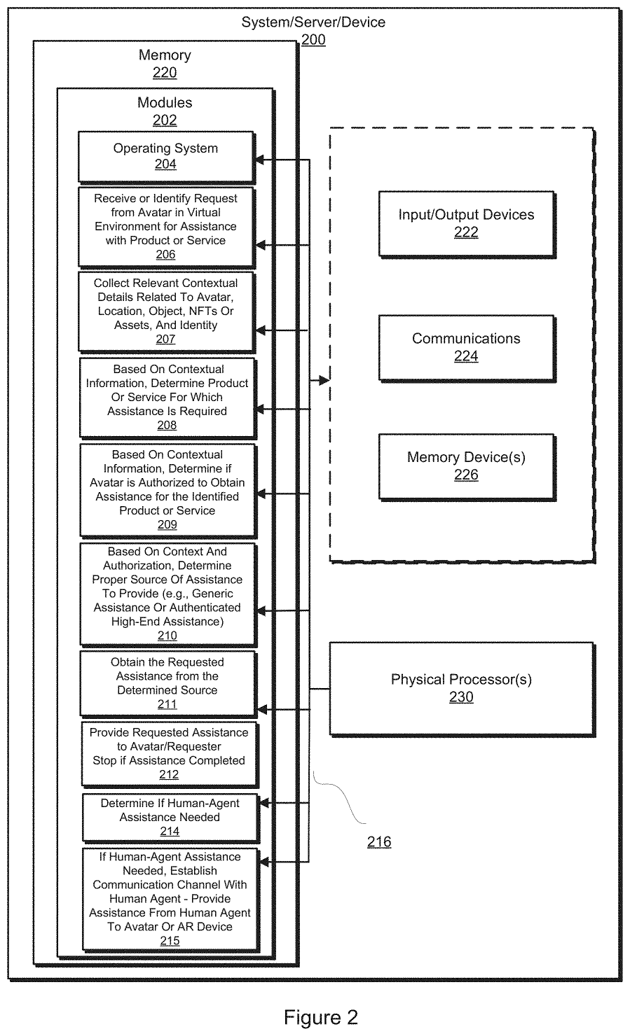

FIG. 2 is a diagram illustrating elements, components, or processes that may be present in or executed by one or more of a computing device, server, platform, or system 200 configured to implement a method, process, function, or operation in accordance with some embodiments. In some embodiments, the disclosed system and methods may be implemented in the form of an apparatus or apparatuses (such as a server that is part of a system or platform, or a client device) that includes a processing element and a set of executable instructions. The executable instructions may be part of a software application (or applications) and arranged into a software architecture.

In general, an embodiment of the disclosure may be implemented using a set of software instructions that are designed to be executed by a suitably programmed processing element (such as a GPU, TPU, CPU, microprocessor, processor, controller, or computing device, as non-limiting examples). In a complex application or system such instructions are typically arranged into “modules” with each such module typically performing a specific task, process, function, or operation. The entire set of modules may be controlled or coordinated in their operation by an operating system (OS) or other form of organizational platform.

The modules and/or sub-modules may include a suitable computer-executable code or set of instructions, such as computer-executable code corresponding to a programming language. For example, programming language source code may be compiled into computer-executable code. Alternatively, or in addition, the programming language may be an interpreted programming language such as a scripting language.

As shown in FIG. 2, system 200 may represent one or more of a server, client device, platform, or other form of computing or data processing device. Modules 202 each contain a set of executable instructions, where when the set of instructions is executed by a suitable electronic processor (such as that indicated in the figure by “Physical Processor(s) 230”), system (or server, or device) 200 operates to perform a specific process, operation, function, or method.

Modules 202 may contain one or more sets of instructions for performing a method or function described with reference to the Figures, and the descriptions of the functions and operations provided in the specification. These modules may include those illustrated but may also include a greater number or fewer number than those illustrated. Further, the modules and the set of computer-executable instructions that are contained in the modules may be executed (in whole or in part) by the same processor or by more than a single processor. If executed by more than a single processor, the co-processors may be contained in different devices, for example a processor in a client device and a processor in a server.

Modules 202 are stored in a memory 220, which typically includes an Operating System module 204 that contains instructions used (among other functions) to access and control the execution of the instructions contained in other modules. The modules 202 in memory 220 are accessed for purposes of transferring data and executing instructions by use of a “bus” or communications line 216, which also serves to permit processor(s) 230 to communicate with the modules for purposes of accessing and executing instructions. Bus or communications line 216 also permits processor(s) 230 to interact with other elements of system 200, such as input or output devices 222, communications elements 224 for exchanging data and information with devices external to system 200, and additional memory devices 226.

Each module or sub-module may correspond to a specific function, method, process, or operation that is implemented by execution of the instructions (in whole or in part) in the module or sub-module. Each module or sub-module may contain a set of computer-executable instructions that when executed by a programmed processor or co-processors cause the processor or co-processors (or a device, devices, server, or servers in which they are contained) to perform the specific function, method, process, or operation. As mentioned, an apparatus in which a processor or co-processor is contained may be one or both of a client device or a remote server or platform. Therefore, a module may contain instructions that are executed (in whole or in part) by the client device, the server or platform, or both. Such function, method, process, or operation may include those used to implement one or more aspects of the disclosed system and methods, such as for:
Receiving or Identifying a Request from an Avatar in a Virtual Environment for Assistance with a Product or Service (as suggested by module 206);
Collecting relevant contextual information related to the avatar, the location of the avatar in the virtual environment, an object, an NFT or asset, and the identity of the avatar (module 207);
Based on the collected contextual information, determining the product or service for which assistance is required (module 208);
Based on the contextual information, determining if the avatar is authorized to obtain assistance for the identified product or service (module 209);
Based on the product or service for which assistance is requested and if the avatar is authorized, determining a proper source of assistance to provide (e.g., generic assistance or authenticated high-end assistance) (module 210);
Obtain the Requested Assistance from the Determined Source (module 211);
Provide the Requested Assistance to the Avatar/Requester-Stop if assistance completed (module 212);
Determine if human-agent assistance is needed to complete the request for assistance (module 214); and
If human-agent assistance is needed, then establish a communication channel with human agent—provide assistance from human agent to avatar or AR device (module 215).

In one embodiment, the disclosed systems and methods may create or supplement a VR experience that demonstrates how to accomplish something (in a VR or AR experience). As an example, suppose a user wants to understand how to kill a monster in a game. They may be directed to go to a FAQ source in the virtual environment, and when they open it, a VR figure emerges which kills the monster and shows how it is done. In an AR example, the system can demonstrate how something would be done by having an AR object do the task.

In one embodiment, a method for providing proof or verification of the identity of a person controlling an avatar within a virtual or augmented reality environment may be implemented. This may be done to provide a confirmed association between an avatar and a real-world person for purposes of executing a transaction, determining ownership of a product or service in the virtual environment, or enabling an avatar to seek assistance with a virtual product or service, as non-limiting examples. In one embodiment, the identity verification method may include the following steps, stages, functions, processes, or operations:
Determine that a request for verification of the real-world identity of a person corresponding to an avatar has been received from an object or event in a virtual environment;
   In one embodiment, this may be the result of an avatar interacting with an object in the virtual environment, an avatar indicating an interest in purchasing, renting, or using an object or service in the virtual environment, or an event being generated within the virtual environment;
   In one embodiment, this may be the result of a person in the real-world indicating an interest in purchasing, renting, or using an object or service in the virtual environment;
In response to the request or event, accessing a blockchain or database containing data comprising:
   Identifiers for a set of avatars in a virtual environment, where each avatar may be associated with a unique name, number, or alphanumeric string, as non-limiting examples;
   For each avatar identifier, an associated set of data or file that may contain one or more of the following, some (or all) of which may be encrypted:
      A name or unique identifier of a real-world person associated with the avatar identifier;
      Information about the real-world person that may be used as part of an authentication process, such as date of birth, last digits of social security number, mother's maiden name, or a favorite color, as non-limiting examples;
      A password or response to a security question;
      A unique identifier associated with an object owned in the virtual environment or a service the avatar is entitled to receive;
Executing a logical process to determine the real-world person that is associated with the avatar responsible for directly or indirectly generating the request for verification, or the avatar associated with the real-world person indicating an interest in purchasing, renting, or using an object or service in the virtual environment;
   Further, determining if the real-world person associated with the avatar is the person controlling the avatar at that time;
      This may involve a form of authentication and/or communication such as;
         Sending a message to the real-world person instructing them to control the avatar in a specific way to do something in the virtual environment;
         Requesting that the real-world person or the avatar provide a previously specified and stored password;
         In some embodiments, this might involve a form of two-factor or two-channel authorization that uses both virtual and real-world devices or processes; and
If the real-world person associated with the avatar is determined to be the person controlling the avatar, and if the real-world person (and hence the avatar) is authorized to execute the desired action or receive the requested assistance, then permitting the avatar or real-world person to perform the action, obtain the assistance, or execute the transaction (as non-limiting examples).

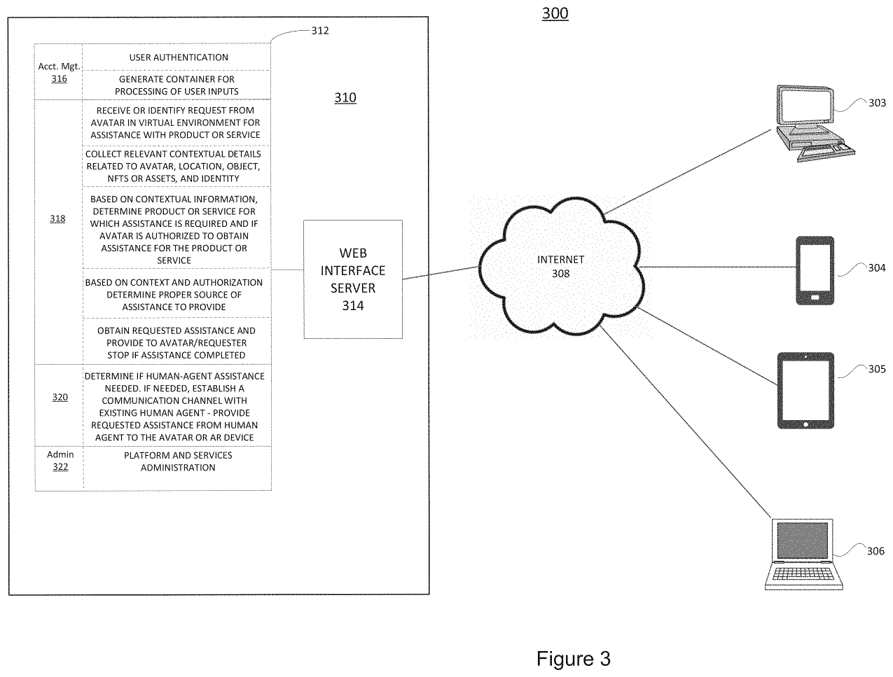

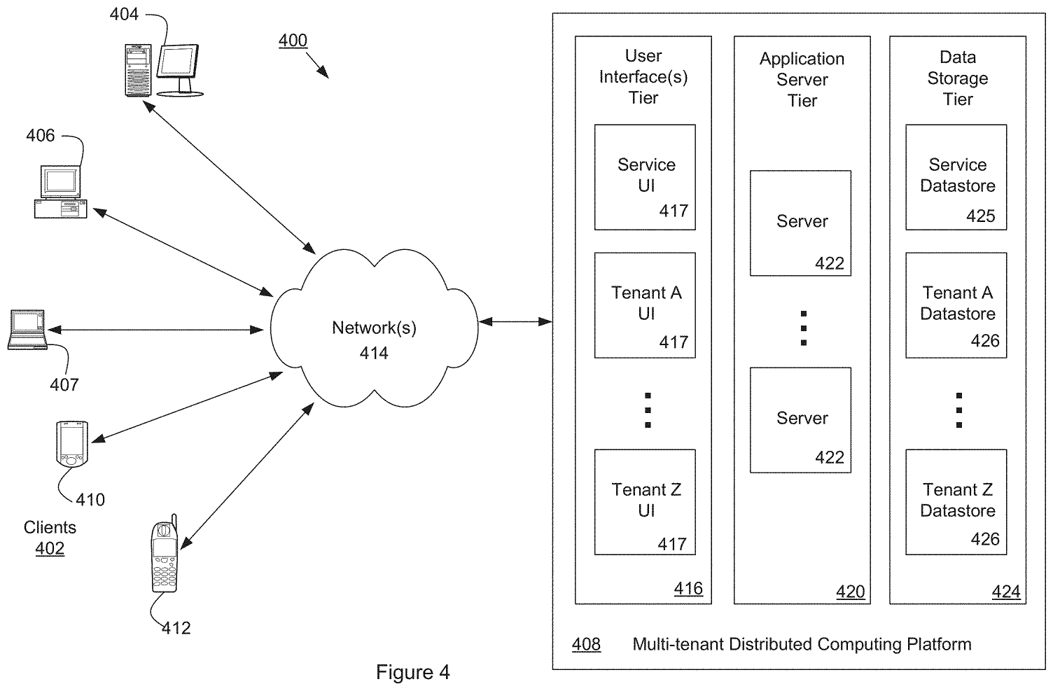

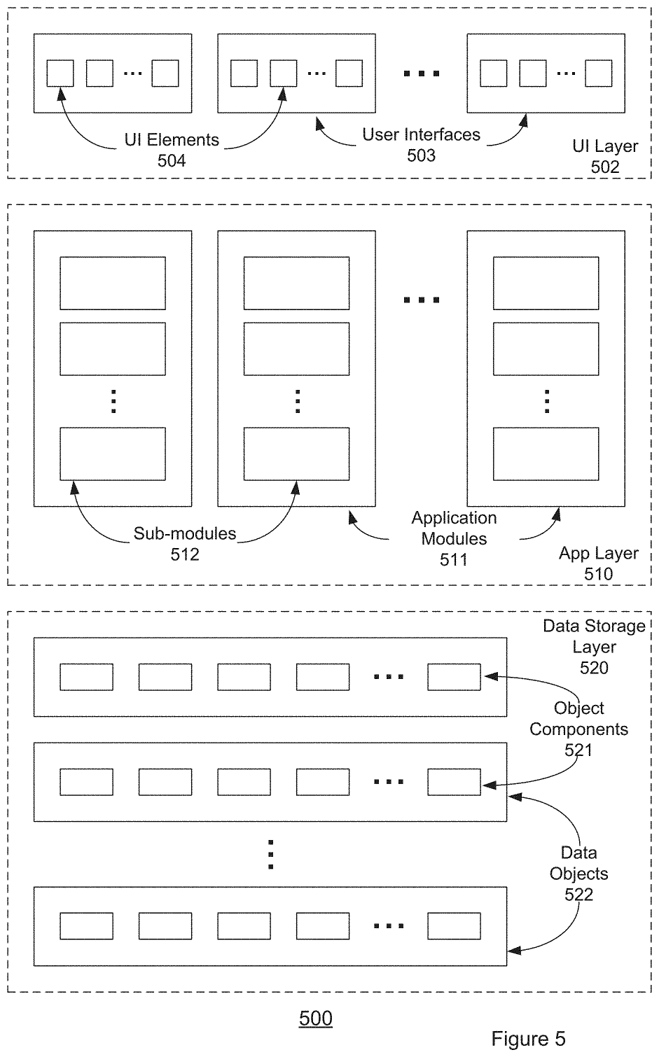

In some embodiments, the functionality and services provided by the system and methods described herein may be made available to multiple users by accessing an account maintained by a server or service platform. Such a server or service platform may be termed a form of Software-as-a-Service (SaaS). FIG. 3 is a diagram illustrating a SaaS system in which an embodiment may be implemented. FIG. 4 is a diagram illustrating elements or components of an example operating environment in which an embodiment may be implemented. FIG. 5 is a diagram illustrating additional details of the elements or components of the multi-tenant distributed computing service platform of FIG. 4, in which an embodiment may be implemented.

In some embodiments, the system or services described herein may be implemented as micro-services, processes, workflows, or functions performed in response to the submission of a service request. The micro-services, processes, workflows, or functions may be performed by a server, data processing element, platform, or system. In some embodiments, the data analysis and other services may be provided by a service platform located “in the cloud”. In such embodiments, the platform may be accessible through APIs and SDKs. The functions, processes and capabilities described herein may be provided as micro-services within the platform. The interfaces to the micro-services may be defined by REST and GraphQL endpoints. An administrative console may allow users or an administrator to securely access the underlying request and response data, manage accounts and access, and in some cases, modify the processing workflow or configuration.

Note that although FIGS. 3-5 illustrate a multi-tenant or SaaS architecture that may be used for the delivery of business-related or other applications and services to multiple accounts/users, such an architecture may also be used to deliver other types of data processing services and provide access to other applications. For example, such an architecture may be used to provide aspects of the customer assistance and support services in a virtual environment disclosed herein. Although in some embodiments, a platform or system of the type illustrated in FIGS. 3-5 may be operated by a 3rd party provider to provide a specific set of business-related applications, in other embodiments, the platform may be operated by a provider and a different business may provide the applications or services for users through the platform.

FIG. 3 is a diagram illustrating a system 300 in which an embodiment may be implemented or through which an embodiment of the services disclosed herein may be accessed. In accordance with the advantages of an application service provider (ASP) hosted business service system (such as a multi-tenant data processing platform), users of the services described herein may comprise individuals, businesses, stores, organizations, etc. A user may access the services using any suitable client, including but not limited to desktop computers, laptop computers, tablet computers, scanners, smartphones, or dedicated VR headsets, for example. In general, any client device having access to the Internet may be used. A user interfaces with the service platform across the Internet 308 or another suitable communications network or combination of networks. Examples of suitable client devices include desktop computers 303, smartphones 304, tablet computers 305, or laptop computers 306.

System 310, which may be hosted by a third party, may include a set of services to assist a user (in the form of their avatar) to obtain customer support within a virtual environment 312, and a web interface server 314, coupled as shown in FIG. 3. It is to be appreciated that either or both services 312 and the web interface server 314 may be implemented on one or more different hardware systems and components, even though represented as singular units in FIG. 3. Services 312 may include one or more functions or operations for providing support or assistance to a user/avatar in a virtual environment.

As examples, in some embodiments, the set of functions, operations or services made available through the platform or system 310 may include:
Account Management services 316, such as
   a process or service to authenticate a user (in conjunction with submission of a user's credentials using the client device);
   a process or service to generate a container or instantiation of the services or applications that will be made available to the user;
User Support Services 318, such as
   a process or service to receive or identify a request from an avatar in virtual environment for assistance with a product or service;
   a process or service to collect relevant contextual information related to the avatar, the location of the avatar in the virtual environment, an object, an NFT or asset, and the identity of the avatar;
   a process or service to, based on the collected contextual information, determine the product or service for which assistance is required and if the avatar is authorized to obtain assistance for the product or service (such as by virtue of the person controlling the avatar being authorized);
   a process or service to, based on the product or service for which assistance is requested and if the avatar is authorized, determine a proper source of assistance to provide;
   a processor service to obtain the requested assistance and provide the assistance to the avatar/requester;
      Stopping the process to provide assistance if the assistance has been completed;
Agent Assistance Services 320, such as
   a process or service to determine if human-agent assistance needed, and if needed, to establish a communication channel with an existing human agent, and provide the requested assistance from the human agent to the avatar or AR device;
Administrative services 322, such as
   a processor services to enable the provider of the services and/or the platform to administer and configure the processes and services provided to users, such as by altering a process flow or available options, for example.

The platform or system shown in FIG. 3 may be hosted on a distributed computing system made up of at least one, but likely multiple, “servers.” A server is a physical computer dedicated to providing data storage and an execution environment for one or more software applications or services intended to serve the needs of the users of other computers that are in data communication with the server, for instance via a public network such as the Internet. The server, and the services it provides, may be referred to as the “host” and the remote computers, and the software applications running on the remote computers being served may be referred to as “clients.” Depending on the computing service(s) that a server offers it could be referred to as a database server, data storage server, file server, mail server, print server, web server, etc. A web server is a most often a combination of hardware and the software that helps deliver content, commonly by hosting a website, to client web browsers that access the web server via the Internet.

FIG. 4 is a diagram illustrating elements or components of an example operating environment 400 in which an embodiment may be implemented. As shown, a variety of clients 402 incorporating and/or incorporated into a variety of computing devices may communicate with a multi-tenant service platform 408 through one or more networks 414. For example, a client may incorporate and/or be incorporated into a client application (i.e., software) implemented at least in part by one or more of the computing devices. Examples of suitable computing devices include personal computers, server computers 404, desktop computers 406, laptop computers 407, notebook computers, tablet computers or personal digital assistants (PDAs) 410, smart phones 412, cell phones, and consumer electronic devices incorporating one or more computing device components, such as one or more electronic processors, microprocessors, central processing units (CPU), or controllers. Examples of suitable networks 414 include networks utilizing wired and/or wireless communication technologies and networks operating in accordance with any suitable networking and/or communication protocol (e.g., the Internet).

The distributed computing service/platform (which may also be referred to as a multi-tenant data processing platform) 408 may include multiple processing tiers, including a user interface tier 416, an application server tier 420, and a data storage tier 424. The user interface tier 416 may maintain multiple user interfaces 417, including graphical user interfaces and/or web-based interfaces. The user interfaces may include a default user interface for the service to provide access to applications and data for a user or “tenant” of the service (depicted as “Service UI” in the figure), as well as one or more user interfaces that have been specialized/customized in accordance with user specific requirements (e.g., represented by “Tenant A UI”, . . . , “Tenant Z UI” in the figure, and which may be accessed via one or more APIs).

The default user interface may include user interface components enabling a tenant to administer the tenant's access to and use of the functions and capabilities provided by the service platform. This may include accessing tenant data, launching an instantiation of a specific application, causing the execution of specific data processing operations, etc. Each application server or processing tier 422 shown in the figure may be implemented with a set of computers and/or components including computer servers and processors, and may perform various functions, methods, processes, or operations as determined by the execution of a software application or set of instructions. The data storage tier 424 may include one or more data stores, which may include a Service Data store 425 and one or more Tenant Data stores 426. Data stores may be implemented with any suitable data storage technology, including structured query language (SQL) based relational database management systems (RDBMS).

Service Platform 408 may be multi-tenant and may be operated by an entity to provide multiple tenants with a set of business-related or other data processing applications, data storage, and functionality. For example, the applications and functionality may include providing web-based access to the functionality used by a business to provide services to end-users, thereby allowing a user with a browser and an Internet or intranet connection to view, enter, process, or modify certain types of information. Such functions or applications are typically implemented by one or more modules of software code/instructions that are maintained on and executed by one or more servers 422 that are part of the platform's Application Server Tier 420. As noted with regards to FIG. 3, the platform system shown in FIG. 4 may be hosted on a distributed computing system made up of at least one, but typically multiple, “servers.”

As mentioned, rather than build and maintain such a platform or system themselves, a business may utilize systems provided by a third party. A third party may implement a business system/platform as described above in the context of a multi-tenant platform, where individual instantiations of a business' data processing workflow (such as the customer assistance processing flow disclosed herein) are provided to users, with each business representing a tenant of the platform. One advantage to such multi-tenant platforms is the ability for each tenant to customize their instantiation of the data processing workflow to that tenant's specific business needs or operational methods. Each tenant may be a business or entity that uses the multi-tenant platform to provide business services and functionality to multiple users.

FIG. 5 is a diagram illustrating additional details of the elements or components of the multi-tenant distributed computing service platform of FIG. 4, in which an embodiment may be implemented. The software architecture shown in FIG. 5 represents an example of an architecture which may be used to implement an embodiment of the disclosure. In general, an embodiment may be implemented using a set of software instructions that are designed to be executed by a suitably programmed processing element (such as a CPU, GPU, microprocessor, processor, controller, or computing device, as non-limiting examples). In a complex system such instructions are typically arranged into “modules” with each such module performing a specific task, process, function, or operation. The entire set of modules may be controlled or coordinated in their operation by an operating system (OS) or other form of organizational platform.

As noted, FIG. 5 is a diagram illustrating additional details of the elements or components 500 of a multi-tenant distributed computing service platform, in which an embodiment may be implemented. The example architecture includes a user interface layer or tier 502 having one or more user interfaces 503. Examples of such user interfaces include graphical user interfaces and application programming interfaces (APIs). Each user interface may include one or more interface elements 504. For example, users may interact with interface elements to access functionality and/or data provided by application and/or data storage layers of the example architecture. Examples of graphical user interface elements include buttons, menus, checkboxes, drop-down lists, scrollbars, sliders, spinners, text boxes, icons, labels, progress bars, status bars, toolbars, windows, hyperlinks, and dialog boxes. Application programming interfaces may be local or remote and may include interface elements such as a variety of controls, parameterized procedure calls, programmatic objects, and messaging protocols.

The application layer 510 may include one or more application modules 511, each having one or more sub-modules 512. Each application module 511 or sub-module 512 may correspond to a function, method, process, or operation that is implemented by the module or sub-module (e.g., a function or process related to providing data processing and services to a user of the platform). Such function, method, process, or operation may include those used to implement one or more aspects of the disclosed system and methods, such as for one or more of the processes or functions disclosed and/or described herein:
Receiving or Identifying a Request from an Avatar in a Virtual Environment for Assistance with a Product or Service;
Collecting relevant contextual information related to the avatar, the location of the avatar in the virtual environment, an object, an NFT or asset, and the identity of the avatar;
Based on the collected contextual information, determining the product or service for which assistance is required;
Based on the contextual information, determining if the avatar (and hence the person controlling the avatar) is authorized to obtain assistance for the determined product or service;
Based on the product or service for which assistance is requested and if the avatar is authorized, determining a proper source of assistance to provide (e.g., generic assistance or authenticated high-end assistance);
Obtaining the Requested Assistance from the Determined Source;
Providing the Requested Assistance to the Avatar/Requester—Stopping if assistance has been completed;
Determining if a human-agent assistance is needed to complete the request for assistance; and
If human-agent assistance is needed, then establishing a communication channel with human agent—provide assistance from human agent to avatar or AR device.

The application modules and/or sub-modules may include any suitable computer-executable code or set of instructions (e.g., as would be executed by a suitably programmed processor, microprocessor, or CPU), such as computer-executable code corresponding to a programming language. For example, programming language source code may be compiled into computer-executable code. Alternatively, or in addition, the programming language may be an interpreted programming language such as a scripting language. Each application server (e.g., as represented by element 422 of FIG. 4) may include each application module. Alternatively, different application servers may include different sets of application modules. Such sets may be disjoint or overlapping.

The data storage layer 520 may include one or more data objects 522 each having one or more data object components 521, such as attributes and/or behaviors. For example, the data objects may correspond to tables of a relational database, and the data object components may correspond to columns or fields of such tables. Alternatively, or in addition, the data objects may correspond to data records having fields and associated services. Alternatively, or in addition, the data objects may correspond to persistent instances of programmatic data objects, such as structures and classes. Each data store in the data storage layer may include each data object. Alternatively, different data stores may include different sets of data objects. Such sets may be disjoint or overlapping.

Note that the example computing environments depicted in FIGS. 3-5 are not intended to be limiting examples. Further environments in which an embodiment of the invention may be implemented in whole or in part include devices (including mobile devices), software applications, systems, apparatuses, networks, SaaS platforms, laaS (infrastructure-as-a-service) platforms, or other configurable components that may be used by multiple users for data entry, data processing, application execution, or data review.

The disclosure includes the following clauses and embodiments:
1. A method of providing a service to a user represented by an avatar in a virtual environment, comprising:
receiving or identifying a request from an avatar in a virtual environment for assistance with a product or service;
collecting relevant contextual information related to one or more of the avatar, the location of the avatar in the virtual environment, an object in the virtual environment, a token or asset associated with the avatar, or an identity of the avatar;
based on the collected contextual information, determining the product or service for which assistance is requested;
based on the collected contextual information, determining if the avatar is authorized to obtain assistance for the determined product or service;
based on the product or service for which assistance is requested and if the avatar is authorized, determining a proper source of assistance to provide to the avatar; obtaining the requested assistance from the determined source;
providing the requested assistance to the avatar; and stopping the process if the request for assistance has been completed.
2. The method of clause 1, further comprising:
determining if human-agent assistance is needed to complete the request for assistance; establishing a communication channel with a human agent; and providing assistance from the human agent to the avatar.
3. The method of clause 1, wherein the contextual information further comprises one or more of:
the product or service name, brand, serial number, model, version, or type;
the source of the product or service;
a relationship between the product or service and the avatar;
a location of the avatar in the virtual environment and the relationship to the product or service for which support is requested;
a location of a real-world person controlling the avatar; and a state or status of the product or service for which assistance is requested.
4. The method of clause 3, wherein the state or status of the product or service for which assistance is requested further comprises one of an error code being generated, a configuration of the product, or a process or function the product was requested to execute or was executing.
5. The method of clause 1, further comprising determining an identity of a person in control of the avatar and verifying that the person is authorized to receive the requested assistance prior to determining if the avatar is authorized to obtain assistance for the determined product or service.
6. The method of clause 5, wherein determining the identity of the person in control of the avatar and verifying that the person is authorized to receive the requested assistance further comprises:
determining that a request for verification of the real-world identity of a person corresponding to an avatar has been received from an object or event in the virtual environment; in response to the request or event, accessing a blockchain or database containing data comprising one or more of an identifier for each of a set of avatars in a virtual environment, where each avatar may be associated with a unique name, number, or alphanumeric string; a name or unique identifier of the real-world person associated with each avatar identifier;
information about the real-world person associated with an avatar identifier that may be used as part of an authentication process;
a password or response to a security question for the real-world person associated with an avatar identifier;
executing a logical process to determine the real-world person that is associated with the avatar responsible for directly or indirectly generating the request for verification; and if the real-world person associated with the avatar is determined to be the person controlling the avatar, and if the real-world person is authorized to execute the desired action, then permitting the avatar or real-world person to receive the requested assistance.
7. A system, comprising:
one or more electronic processors configured to execute a set of computer-executable instructions; and one or more non-transitory computer-readable media containing the set of computer-executable instructions, wherein when executed, the instructions cause the one or more electronic processors or a device or apparatus of which they are part to receive or identify a request from an avatar in a virtual environment for assistance with a product or service;
collect relevant contextual information related to one or more of the avatar, the location of the avatar in the virtual environment, an object in the virtual environment, an NFT or asset associated with the avatar, or an identity of the avatar;
based on the collected contextual information, determine the product or service for which assistance is requested;
based on the collected contextual information, determine if the avatar is authorized to obtain assistance for the determined product or service;
based on the product or service for which assistance is requested and if the avatar is authorized, determine a proper source of assistance to provide;
obtain the requested assistance from the determined source;
provide the requested assistance to the avatar; and stop the process if the request for assistance has been completed.
8. The system of clause 7, further comprising instructions that cause the one or more electronic processors or a device or apparatus of which they are part to:
determine if human-agent assistance is needed to complete the request for assistance; establish a communication channel with a human agent; and provide assistance from the human agent to the avatar.
9. The system of clause 7, wherein the contextual information further comprises one or more of:
the product or service name, brand, serial number, model, version, or type;
the source of the product or service;
a relationship between the product or service and the avatar;
a location of the avatar in the virtual environment and the relationship to the product or service for which support is requested;
a location of a real-world person controlling the avatar; and a state or status of the product or service for which assistance is requested.
10. The system of clause 9, wherein the state or status of the product or service for which assistance is requested further comprises one of an error code being generated, a configuration of the product, or a process or function the product was requested to execute or was executing.
11. The system of clause 7, further comprising instructions that cause the one or more electronic processors or a device or apparatus of which they are part to determine an identity of a person in control of the avatar and verify that the person is authorized to receive the requested assistance prior to determining if the avatar is authorized to obtain assistance for the determined product or service.
12. The system of clause 11, wherein determining the identity of the person in control of the avatar and verifying that the person is authorized to receive the requested assistance further comprises:
determining that a request for verification of the real-world identity of a person corresponding to an avatar has been received from an object or event in the virtual environment;
in response to the request or event, accessing a blockchain or database containing data comprising one or more of
   an identifier for each of a set of avatars in a virtual environment, where each avatar may be associated with a unique name, number, or alphanumeric string;
   a name or unique identifier of the real-world person associated with each avatar identifier;
   information about the real-world person associated with an avatar identifier that may be used as part of an authentication process;
   a password or response to a security question for the real-world person associated with an avatar identifier;
executing a logical process to determine the real-world person that is associated with the avatar responsible for directly or indirectly generating the request for verification; and if the real-world person associated with the avatar is determined to be the person controlling the avatar, and if the real-world person is authorized to execute the desired action, then permitting the avatar or real-world person to receive the requested assistance.
13. One or more non-transitory computer-readable media comprising a set of computer-executable instructions that when executed by one or more programmed electronic processors, cause the processors or a device or apparatus of which they are part to:
receive or identify a request from an avatar in a virtual environment for assistance with a product or service;
collect relevant contextual information related to one or more of the avatar, the location of the avatar in the virtual environment, an object in the virtual environment, an NFT or asset associated with the avatar, or an identity of the avatar;
based on the collected contextual information, determine the product or service for which assistance is requested;
based on the collected contextual information, determine if the avatar is authorized to obtain assistance for the determined product or service;
based on the product or service for which assistance is requested and if the avatar is authorized, determine a proper source of assistance to provide;
obtain the requested assistance from the determined source;
provide the requested assistance to the avatar; and stop the process if the request for assistance has been completed.
14. The non-transitory computer-readable media of clause 13, wherein the instructions further cause the one or more electronic processors or a device or apparatus of which they are part to:
determine if human-agent assistance is needed to complete the request for assistance;
establish a communication channel with a human agent; and
provide assistance from the human agent to the avatar.
15. The non-transitory computer-readable media of clause 13, wherein the contextual information further comprises one or more of:
the product or service name, brand, serial number, model, version, or type;
the source of the product or service;
a relationship between the product or service and the avatar;
a location of the avatar in the virtual environment and the relationship to the product or service for which support is requested;
a location of a real-world person controlling the avatar; and
a state or status of the product or service for which assistance is requested.
16. The non-transitory computer-readable media of clause 15, wherein the state or status of the product or service for which assistance is requested further comprises one of an error code being generated, a configuration of the product, or a process or function the product was requested to execute or was executing.
17. The non-transitory computer-readable media of clause 13, wherein the instructions further cause the one or more electronic processors or a device or apparatus of which they are part to determine an identity of a person in control of the avatar and verify that the person is authorized to receive the requested assistance prior to determining if the avatar is authorized to obtain assistance for the determined product or service.
18. The non-transitory computer-readable media of clause 17, wherein determining the identity of the person in control of the avatar and verifying that the person is authorized to receive the requested assistance further comprises:
determining that a request for verification of the real-world identity of a person corresponding to an avatar has been received from an object or event in the virtual environment;
in response to the request or event, accessing a blockchain or database containing data comprising one or more of
   an identifier for each of a set of avatars in a virtual environment, where each avatar may be associated with a unique name, number, or alphanumeric string;
   a name or unique identifier of the real-world person associated with each avatar identifier;
   information about the real-world person associated with an avatar identifier that may be used as part of an authentication process;
   a password or response to a security question for the real-world person associated with an avatar identifier;
executing a logical process to determine the real-world person that is associated with the avatar responsible for directly or indirectly generating the request for verification; and
if the real-world person associated with the avatar is determined to be the person controlling the avatar, and if the real-world person is authorized to execute the desired action, then permitting the avatar or real-world person to receive the requested assistance.

The disclosed system and methods can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Machine learning (ML) is being used more and more to enable the analysis of data and assist in making decisions in multiple industries. To benefit from using machine learning, a machine learning algorithm is applied to a set of training data and labels to generate a “model” which represents what the application of the algorithm has “learned” from the training data. Each element (or instances or example, in the form of one or more parameters, variables, characteristics or “features”) of the set of training data is associated with a label or annotation that defines how the element should be classified by the trained model. A machine learning model in the form of a neural network is a set of layers of connected neurons that operate to make a decision (such as a classification) regarding a sample of input data. When trained (i.e., the weights connecting neurons have converged and become stable or within an acceptable amount of variation), the model will operate on a new element of input data to generate the correct label or classification as an output.

In some embodiments, certain of the methods, models or functions described herein may be embodied in the form of a trained neural network, where the network is implemented by the execution of a set of computer-executable instructions or representation of a data structure. The instructions may be stored in (or on) a non-transitory computer-readable medium and executed by a programmed processor or processing element. The set of instructions may be conveyed to a user through a transfer of instructions or an application that executes a set of instructions (such as over a network, e.g., the Internet). The set of instructions or an application may be utilized by an end-user through access to a SaaS platform or a service provided through such a platform. A trained neural network, trained machine learning model, or any other form of decision or classification process may be used to implement one or more of the methods, functions, processes, or operations described herein. Note that a neural network or deep learning model may be characterized in the form of a data structure in which are stored data representing a set of layers containing nodes, and connections between nodes in different layers are created (or formed) that operate on an input to provide a decision or value as an output.

In general terms, a neural network may be viewed as a system of interconnected artificial “neurons” or nodes that exchange messages between each other. The connections have numeric weights that are “tuned” during a training process, so that a properly trained network will respond correctly when presented with an image or pattern to recognize (for example). In this characterization, the network consists of multiple layers of feature-detecting “neurons”; each layer has neurons that respond to different combinations of inputs from the previous layers. Training of a network is performed using a “labeled” dataset of inputs in a wide assortment of representative input patterns that are associated with their intended output response. Training uses general-purpose methods to iteratively determine the weights for intermediate and final feature neurons. In terms of a computational model, each neuron calculates the dot product of inputs and weights, adds the bias, and applies a non-linear trigger or activation function (for example, using a sigmoid response function).

Any of the software components, processes or functions described in this application may be implemented as software code to be executed by a processor using any suitable computer language such as Python, Java, JavaScript, C, C++, or Perl using conventional or object-oriented techniques. The software code may be stored as a series of instructions, or commands in (or on) a non-transitory computer-readable medium, such as a random-access memory (RAM), a read only memory (ROM), a magnetic medium such as a hard-drive or a floppy disk, or an optical medium such as a CD-ROM. In this context, a non-transitory computer-readable medium is almost any medium suitable for the storage of data or an instruction set aside from a transitory waveform. Any such computer readable medium may reside on or within a single computational apparatus and may be present on or within different computational apparatuses within a system or network.

According to one example implementation, the term processing element or processor, as used herein, may be a central processing unit (CPU), or conceptualized as a CPU (such as a virtual machine). In this example implementation, the CPU or a device in which the CPU is incorporated may be coupled, connected, and/or in communication with one or more peripheral devices, such as display. In another example implementation, the processing element or processor may be incorporated into a mobile computing device, such as a smartphone or tablet computer.

The non-transitory computer-readable storage medium referred to herein may include a number of physical drive units, such as a redundant array of independent disks (RAID), a floppy disk drive, a flash memory, a USB flash drive, an external hard disk drive, thumb drive, pen drive, key drive, a High-Density Digital Versatile Disc (HD-DV D) optical disc drive, an internal hard disk drive, a Blu-Ray optical disc drive, or a Holographic Digital Data Storage (HDDS) optical disc drive, synchronous dynamic random access memory (SDRAM), or similar devices or other forms of memories based on similar technologies. Such computer-readable storage media allow the processing element or processor to access computer-executable process steps, application programs and the like, stored on removable and non-removable memory media, to off-load data from a device or to upload data to a device. As mentioned, with regards to the embodiments described herein, a non-transitory computer-readable medium may include almost any structure, technology, or method apart from a transitory waveform or similar medium.

Certain implementations of the disclosed technology are described herein with reference to block diagrams of systems, and/or to flowcharts or flow diagrams of functions, operations, processes, or methods. It will be understood that one or more blocks of the block diagrams, or one or more stages or steps of the flowcharts or flow diagrams, and combinations of blocks in the block diagrams and stages or steps of the flowcharts or flow diagrams, respectively, can be implemented by computer-executable program instructions. Note that in some embodiments, one or more of the blocks, or stages or steps may not necessarily need to be performed in the order presented or may not necessarily need to be performed at all.

These computer-executable program instructions may be loaded onto a general-purpose computer, a special purpose computer, a processor, or other programmable data processing apparatus to produce a specific example of a machine, such that the instructions that are executed by the computer, processor, or other programmable data processing apparatus create means for implementing one or more of the functions, operations, processes, or methods described herein. These computer program instructions may also be stored in a computer-readable memory that can direct a computer or other programmable data processing apparatus to function in a specific manner, such that the instructions stored in the computer-readable memory produce an article of manufacture including instruction means that implement one or more of the functions, operations, processes, or methods described herein.

While certain implementations of the disclosed technology have been described in connection with what is presently considered to be the most practical and various implementations, it is to be understood that the disclosed technology is not to be limited to the disclosed implementations. Instead, the disclosed implementations are intended to cover various modifications and equivalent arrangements included within the scope of the appended claims. Although specific terms are employed herein, they are used in a generic and descriptive sense only and not for purposes of limitation.

This written description uses examples to disclose certain implementations of the disclosed technology, and to enable any person skilled in the art to practice certain implementations of the disclosed technology, including making and using any devices or systems and performing any incorporated methods. The patentable scope of certain implementations of the disclosed technology is defined in the claims, and may include other examples that occur to those skilled in the art. Such other examples are intended to be within the scope of the claims if they have structural and/or functional elements that do not differ from the literal language of the claims, or if they include structural and/or functional elements with insubstantial differences from the literal language of the claims.

All references, including publications, patent applications, and patents, cited herein are hereby incorporated by reference to the same extent as if each reference were individually and specifically indicated to be incorporated by reference and/or were set forth in its entirety herein.

The use of the terms “a” and “an” and “the” and similar referents in the specification and in the following claims are to be construed to cover both the singular and the plural, unless otherwise indicated herein or clearly contradicted by context. The terms “having,” “including,” “containing” and similar referents in the specification and in the following claims are to be construed as open-ended terms (e.g., meaning “including, but not limited to,”) unless otherwise noted. Recitation of ranges of values herein are merely intended to serve as a shorthand method of referring individually to each separate value inclusively falling within the range, unless otherwise indicated herein, and each separate value is incorporated into the specification as if it were individually recited herein. All methods described herein can be performed in any suitable order unless otherwise indicated herein or clearly contradicted by context. The use of any and all examples, or exemplary language (e.g., “such as”) provided herein, is intended merely to better illuminate embodiments of the invention and does not pose a limitation to the scope of the invention unless otherwise claimed. No language in the specification should be construed as indicating any non-claimed element as essential to each embodiment of the present invention.

As used herein (i.e., the claims, figures, and specification), the term “or” is used inclusively to refer to items in the alternative and in combination.

Different arrangements of the components depicted in the drawings or described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications can be made without departing from the scope of the claims below.

That which is claimed is:

1. A method of providing a service to a user represented by an avatar in a virtual environment, comprising:
receiving or identifying a request from an avatar in a virtual environment for assistance with a product or service;
collecting relevant contextual information related to one or more of the avatar, the location of the avatar in the virtual environment, an object in the virtual environment, a token or asset associated with the avatar, or an identity of the avatar;
based on the collected contextual information, determining the product or service for which assistance is requested;
based on the collected contextual information, determining if the avatar is authorized to obtain assistance for the determined product or service;
based on the product or service for which assistance is requested and if the avatar is authorized, determining a proper source of assistance to provide to the avatar;
obtaining the requested assistance from the determined source;
providing the requested assistance to the avatar; and
stopping the process if the request for assistance has been completed.

2. The method of claim 1, further comprising:
determining if human-agent assistance is needed to complete the request for assistance;
establishing a communication channel with a human agent; and
providing assistance from the human agent to the avatar.

3. The method of claim 1, wherein the contextual information further comprises one or more of:
the product or service name, brand, serial number, model, version, or type;
the source of the product or service;
a relationship between the product or service and the avatar;
a location of the avatar in the virtual environment and the relationship to the product or service for which support is requested;
a location of a real-world person controlling the avatar; and
a state or status of the product or service for which assistance is requested.

4. The method of claim 3, wherein the state or status of the product or service for which assistance is requested further comprises one of an error code being generated, a configuration of the product, or a process or function the product was requested to execute or was executing.

5. The method of claim 1, further comprising determining an identity of a person in control of the avatar and verifying that the person is authorized to receive the requested assistance prior to determining if the avatar is authorized to obtain assistance for the determined product or service.

6. The method of claim 5, wherein determining the identity of the person in control of the avatar and verifying that the person is authorized to receive the requested assistance further comprises:
determining that a request for verification of the real-world identity of a person corresponding to an avatar has been received from an object or event in the virtual environment;
in response to the request or event, accessing a blockchain or database containing data comprising one or more of
an identifier for each of a set of avatars in a virtual environment, where each avatar may be associated with a unique name, number, or alphanumeric string;
a name or unique identifier of the real-world person associated with each avatar identifier;
information about the real-world person associated with an avatar identifier that may be used as part of an authentication process;
a password or response to a security question for the real-world person associated with an avatar identifier;
executing a logical process to determine the real-world person that is associated with the avatar responsible for directly or indirectly generating the request for verification; and
if the real-world person associated with the avatar is determined to be the person controlling the avatar, and if the real-world person is authorized to execute the desired action, then permitting the avatar or real-world person to receive the requested assistance.

7. A system, comprising:
one or more electronic processors configured to execute a set of computer-executable instructions; and
one or more non-transitory computer-readable media containing the set of computer-executable instructions, wherein when executed, the instructions cause the one or more electronic processors or a device or apparatus of which they are part to
receive or identify a request from an avatar in a virtual environment for assistance with a product or service;
collect relevant contextual information related to one or more of the avatar, the location of the avatar in the virtual environment, an object in the virtual environment, an NFT or asset associated with the avatar, or an identity of the avatar;
based on the collected contextual information, determine the product or service for which assistance is requested;
based on the collected contextual information, determine if the avatar is authorized to obtain assistance for the determined product or service;
based on the product or service for which assistance is requested and if the avatar is authorized, determine a proper source of assistance to provide;
obtain the requested assistance from the determined source;
provide the requested assistance to the avatar; and
stop the process if the request for assistance has been completed.

8. The system of claim 7, further comprising instructions that cause the one or more electronic processors or a device or apparatus of which they are part to:
determine if human-agent assistance is needed to complete the request for assistance;
establish a communication channel with a human agent; and
provide assistance from the human agent to the avatar.

9. The system of claim 7, wherein the contextual information further comprises one or more of:
the product or service name, brand, serial number, model, version, or type;
the source of the product or service;
a relationship between the product or service and the avatar;
a location of the avatar in the virtual environment and the relationship to the product or service for which support is requested;
a location of a real-world person controlling the avatar; and
a state or status of the product or service for which assistance is requested.

10. The system of claim 9, wherein the state or status of the product or service for which assistance is requested further comprises one of an error code being generated, a configuration of the product, or a process or function the product was requested to execute or was executing.

11. The system of claim 7, further comprising instructions that cause the one or more electronic processors or a device or apparatus of which they are part to determine an identity of a person in control of the avatar and verify that the person is authorized to receive the requested assistance prior to determining if the avatar is authorized to obtain assistance for the determined product or service.

12. The system of claim 11, wherein determining the identity of the person in control of the avatar and verifying that the person is authorized to receive the requested assistance further comprises:
determining that a request for verification of the real-world identity of a person corresponding to an avatar has been received from an object or event in the virtual environment;
in response to the request or event, accessing a blockchain or database containing data comprising one or more of
an identifier for each of a set of avatars in a virtual environment, where each avatar may be associated with a unique name, number, or alphanumeric string;
a name or unique identifier of the real-world person associated with each avatar identifier;
information about the real-world person associated with an avatar identifier that may be used as part of an authentication process;
a password or response to a security question for the real-world person associated with an avatar identifier;
executing a logical process to determine the real-world person that is associated with the avatar responsible for directly or indirectly generating the request for verification; and
if the real-world person associated with the avatar is determined to be the person controlling the avatar, and if the real-world person is authorized to execute the desired action, then permitting the avatar or real-world person to receive the requested assistance.

13. One or more non-transitory computer-readable media comprising a set of computer-executable instructions that when executed by one or more programmed electronic processors, cause the processors or a device or apparatus of which they are part to:
receive or identify a request from an avatar in a virtual environment for assistance with a product or service;
collect relevant contextual information related to one or more of the avatar, the location of the avatar in the virtual environment, an object in the virtual environment, an NFT or asset associated with the avatar, or an identity of the avatar;
based on the collected contextual information, determine the product or service for which assistance is requested;
based on the collected contextual information, determine if the avatar is authorized to obtain assistance for the determined product or service;
based on the product or service for which assistance is requested and if the avatar is authorized, determine a proper source of assistance to provide;
obtain the requested assistance from the determined source;
provide the requested assistance to the avatar; and
stop the process if the request for assistance has been completed.

14. The non-transitory computer-readable media of claim 13, wherein the instructions further cause the one or more electronic processors or a device or apparatus of which they are part to:
determine if human-agent assistance is needed to complete the request for assistance;
establish a communication channel with a human agent; and
provide assistance from the human agent to the avatar.

15. The non-transitory computer-readable media of claim 13, wherein the contextual information further comprises one or more of:
the product or service name, brand, serial number, model, version, or type;
the source of the product or service;
a relationship between the product or service and the avatar;
a location of the avatar in the virtual environment and the relationship to the product or service for which support is requested;
a location of a real-world person controlling the avatar; and
a state or status of the product or service for which assistance is requested.

16. The non-transitory computer-readable media of claim 15, wherein the state or status of the product or service for which assistance is requested further comprises one of an error code being generated, a configuration of the product, or a process or function the product was requested to execute or was executing.

17. The non-transitory computer-readable media of claim 13, wherein the instructions further cause the one or more electronic processors or a device or apparatus of which they are part to determine an identity of a person in control of the avatar and verify that the person is authorized to receive the requested assistance prior to determining if the avatar is authorized to obtain assistance for the determined product or service.

18. The non-transitory computer-readable media of claim 17, wherein determining the identity of the person in control of the avatar and verifying that the person is authorized to receive the requested assistance further comprises:
determining that a request for verification of the real-world identity of a person corresponding to an avatar has been received from an object or event in the virtual environment;
in response to the request or event, accessing a blockchain or database containing data comprising one or more of
an identifier for each of a set of avatars in a virtual environment, where each avatar may be associated with a unique name, number, or alphanumeric string;
a name or unique identifier of the real-world person associated with each avatar identifier;
information about the real-world person associated with an avatar identifier that may be used as part of an authentication process;
a password or response to a security question for the real-world person associated with an avatar identifier;
executing a logical process to determine the real-world person that is associated with the avatar responsible for directly or indirectly generating the request for verification; and
if the real-world person associated with the avatar is determined to be the person controlling the avatar, and if the real-world person is authorized to execute the desired action, then permitting the avatar or real-world person to receive the requested assistance.
